(19) United States
(12) Patent Application Publication
(10) Pub. No.: US 2013/0097217 A1
(43) Pub. Date: Apr. 18, 2013

(54) SYSTEM, METHOD AND APPARATUS FOR PROPRIETARY DATA ARCHIVAL DIRECTORY AND TRANSACTION SERVICES

(71) Applicant: UBITERRA CORPORATION, Denver, CO (US)

(72) Inventor: Peter W. Flanagan, Denver, CO (US)

(73) Assignee: UBITERRA CORPORATION, Denver, CO (US)

(21) Appl. No.: 13/657,490

(22) Filed: Oct. 22, 2012

Related U.S. Application Data
(63) Continuation-in-part of application No. 13/654,316, filed on Oct. 17, 2012.
(60) Provisional application No. 61/549,392, filed on Oct. 20, 2011.
(60) Provisional application No. 61/548,593, filed on Oct. 18, 2011.
(60) Provisional application No. 61/548,580, filed on Oct. 18, 2011.

(51) Int. Cl. G06F 15/16

(52) U.S. Cl. 709/201

(57) ABSTRACT

A transaction service whereby a first party, such as the owner of a data set, may make data sets available for some form of transaction, such as to transform the data for the owner, a license to a second party for the data, or an acquisition of the data by a second party. The service may be deployed in conjunction with a system that provides efficient mechanism to partition the data set and store it into nodes, as well as to retrieve portions of the data set. As part of the service, the owner can register the data set for a transaction and second parties, such as contractors or partners, can be notified of such registrations such as through some form of electronic notification or through having the data set listed or otherwise provided on a viewable page or pages provided by the service.

### CROSS REFERENCE TO RELATED APPLICATIONS

The present application is a non-provisional application claiming priority under 35 U.S.C. §119(e) to provisional application No. 61/549,392 titled “A System, Method and Apparatus for Provision of Proprietary Data Archival, Directory and Transaction Services,” filed on Oct. 20, 2012, which is hereby incorporated by reference herein.

The present application is continuation-in-part of application Ser. No. 13/654,316 titled “APPARATUS, SYSTEM AND METHOD FOR THE EFFICIENT STORAGE AND RETRIEVAL OF 3-DIMENSIONALLY ORGANIZED DATA IN CLOUD-BASED COMPUTING ARCHITECTURES,” filed on Oct. 18, 2012, the disclosure of which is hereby incorporated by reference herein, and which claims priority to provisional application No. 61/548,593 titled “METHOD FOR EFFICIENT STORAGE AND RETRIEVAL OF 3 DIMENSIONALLY ORGANIZED SAMPLE DATA IN CLOUD-BASED COMPUTING ARCHITECTURES” filed on Oct. 18, 2011, the disclosure of which is hereby incorporated by reference herein, and provisional application No. 61/548,580 titled “METHOD FOR CACHING OF CROSS-SECTIONS AND SLICES OF 3 DIMENSIONALLY ORGANIZED SAMPLES DATA IN CLOUD-BASED COMPUTING ARCHITECTURES” filed on Oct. 18, 2011, the disclosure of which is hereby incorporated by reference herein.

### TECHNICAL FIELD

Aspects of the present disclosure involve a data transaction service, and more particular involve an apparatus, system and method for providing directory services, archiving or storage services, and transaction services, among other functions, for proprietary data sets where such data sets may be made available to parties, besides the owners, for some form of use.

### BACKGROUND

A number of scientific methods involve collecting sample data in a 3-dimensionally organized form. For example, seismic exploration data, collected in efforts to identify natural gas, oil, water and other underground resources, involves data in the x and y horizontal planes as well as z plane data typically associated with time. To collect the raw data, a seismic survey is conduced that involves seismic waves (essentially sound waves) that are created on the earth's surface. The waves may be initiated in any number of ways including through the use of dynamite or seismic vibrators. As the waves propagate downward, portions of the waves reflect back to the surface when the waves interact with an underground object, layers, or any number of other possible underground features. The reflected wave data is collected over a wide geographic area. The raw collected data is stored and converted, such as through a process sometimes referred to as stacking, into a form, such as a seismic stack, that can show various underground objects and features in a human readable way through various types of software and user interfaces. Geologists, geophysicists, and others, using the processed data and tools can then interpret the data and to identify those features associated with the presence of natural gas, shale, oil, water, and other things.

In the case of a seismic stack, a person will often view various slices or cross-sections of the processed stack data taken along the x-axis (inline), the y-axis (crossline), the z-axis (slice or time direction) or some combination thereof. Since the stack represents a 3-D image of a large underground cube, by viewing various slices through the data, a person can see changes in features, identify underground shapes and contours, and numerous other characteristics of the data. These data sets can be massive, on the order of 10s or more gigabytes of data in some instances. Visualizing and working with the data requires large amounts of fast data storage and fast processors.

In the oil and gas industry in the United States and other countries, information that is gathered when a well is drilled may be is put into the public domain. Placing the information in the public domain is done for various reasons and overall is done for the common good and to make exploration efforts more efficient. The publicly available information placed in the public domain includes well locations, well tops, oil and gas production figures, among other information.

Some information and particularly the seismic data discussed above, however, is not placed in the public domain. This information instead remains proprietary. Nonetheless, companies buy, sell and trade these valuable datasets as areas are explored and often re-explored. The proprietary data may include the raw seismic data, as well as derivative data such as maps, the slices referenced above, prospects and other information obtained or derived based on the primary seismic stack data or the raw data.

Currently, there is no comprehensive and interactive directory for such proprietary data and there is no mechanism by which companies can efficiently determine what data exists and of that data, what data might be bought, accessed or licensed. Similarly, there is no automated way to preview such data or obtain rights to access such data. Finally, there is no mechanism for the efficient electronic access, sharing and use of such data.

It is with these issues in mind, among others, that various aspects of the present disclosure were developed.

### SUMMARY

Aspects of the present disclosure involve a method of providing a party access to proprietary multi-dimensional data sets. This method may occur at a computer or may be encoded on a tangible computer medium as computer executable instructions. In any event, at one or more computer servers configured to provide a data set transaction service, the method involves receiving a proprietary data set, such as a seismic data set, whether 2-D or 3-D or other forms of data, from a first party. The proprietary data set is partitioned and stored across a plurality of storage nodes. The method also involves obtaining registration information for the data set. The registration information includes at least one indication that the data set is available for a transaction, such as licensing the data, acquiring the data, or providing access so that a party may manipulate or otherwise process the data into other forms. Finally, the method also involves providing for notification that the data set is available for a transaction. The notification may be active, such as through an alert on a web page or an automatically generated email, or the notification may be through posting or otherwise making the data set viewable on a portion of the site that is publicly accessible and viewable.

Aspects of the present disclosure also involve a system of providing a party access to proprietary multi-dimensional data sets, where the system involves at least one computer server including a computer readable media having instructions thereon for providing a data set transaction service. The data transaction service is configured to receive a proprietary data set from a first party. The service is further configured to obtain registration information for the data set where the registration information includes at least one indication that the data set is available for a transaction. Finally, the services is configured to provide for notification that the data set is available for a transaction.

### BRIEF DESCRIPTION OF THE DRAWINGS

Aspects of the present disclosure may be better understood and its numerous objects, features, and advantages made apparent to those skilled in the art by referencing the accompanying drawings. It should be understood that these drawings depict only typical embodiments of the present disclosure and, therefore, are not to be considered limiting in scope.

FIG. 1 is a system diagram depicting a network, including a cloud storage network, and remote devices connected to the network, the system configured to partition and store 3-D data into distributed storage within the cloud storage network and to facilitate transactions on the data and otherwise sharing of the data between parties, in accordance with one embodiment of the present disclosure;

FIG. 2 is a logical flow between a 3-D cube through partitioning and the storage of the partitions in distinct storage nodes;

FIG. 3 is a flow diagram depicting one method of using the system to register a data set, make the data set available for a transaction with a second party, and transfer that data set to the third party, among other operations, I accordance with one embodiment of the present disclosure;

FIG. 4 is an example of catalog entries or fields for a seismic data set, in accordance with one embodiment of the present disclosure;

FIG. 5A is an example of a GUI by which an owner may view data sets stored with the system, and may select a data set to make the set available for a transaction, among other operations, in accordance with one embodiment of the present disclosure;

FIG. 5B is an example of a GUI by which an owner may define transaction and preview areas of a data set being made available for a transaction, in accordance with one embodiment of the present disclosure;

FIG. 6 is an example of a GUI by which a second party may view a data set available for a transaction and communicate with the owner concerning the same, among other operations, in accordance with one embodiment of the present disclosure;

FIG. 7 is an area of interest database entry in accordance with one embodiment of the present disclosure;

FIGS. 8A-8C are series of GUI's whereby an owner may transfer some or all of a data set to a second party based on a transaction or transfer sought by the owner, in accordance with aspects of the present disclosure; and

FIG. 9 is a diagram depicting a computer architecture for one possible general purpose computing device for use with various aspects of the present disclosure.

### DETAILED DESCRIPTION

Aspects of the present disclosure involve apparatus, systems and methods for the efficient storage, retrieval and sharing of 3-dimensionally (3-D) organized sample data in cloud-based computing architectures and other architectures. The systems described herein may provide directory and transaction services related to data sets in addition to efficient storage and retrieval of the same. More particularly, aspects of the present disclosure involve uploading data into partitions of a cloud storage arrangement. While the transaction services discussed herein takes advantage of a distributed and partitioned cloud storage architecture, the transaction services discussed herein may be accomplished in more conventional storage architectures so long as the participants can conduct transactions discussed herein. During or after uploading the data, the data may be registered and made publically available for licensing or other transactions with third parties. The owner can make some or all of the data available, and can also make other aspects of the data available. The system also identifies the available data, such as through a digital map or notifications, to interested parties, also referred to herein as “partners.” Should a partner obtain a license or other rights to access the data of the owner, copies of the data are stored in storage partitions accessible by the partner. The partner may also be a contractor that will perform some action on the data set for the owner. The host of the system may obtain an electronic transfer of a fee associated with transactions between owner and parties.

Other aspects of the present disclosure involve partitioning 3-dimensionally organized data and storing the partitions in distinct storage partitions within a cloud storage arrangement. The storage partitions may be associated with independent and dedicated processing threads and controls such that the data partitions may be written into storage and read from storage partially or completely in parallel. The data may be partitioned based on different axes of the 3-dimensional data set, and stored in the cloud partitions based on the partitioning of the data. The data may also be selectively read from the various cloud partitions so that different aspects of the data may be read without reading the entirety of the 3-D data stored. Reading, like writing the data, may also occur in parallel.

The various apparatus, systems and methods discussed herein provide for efficient storage and retrieval of massive 3-dimenstionally organized data to and from the cloud, access and sharing of the data across the world, greater data security, and numerous other advantages and efficiencies over conventional systems. The example implementation discussed herein reference the 3-D data as a seismic stack. However, the present disclosure is applicable to any number of other types of 3-D data such as medical data (e.g., magnetic resonance imaging (MRI)), oceanic data, weather data, etc. Some details of the partitioning operations and retrieval operations are disclosed more fully in U.S. application Ser. No. 13/654,316, which is referenced above and incorporated herein.

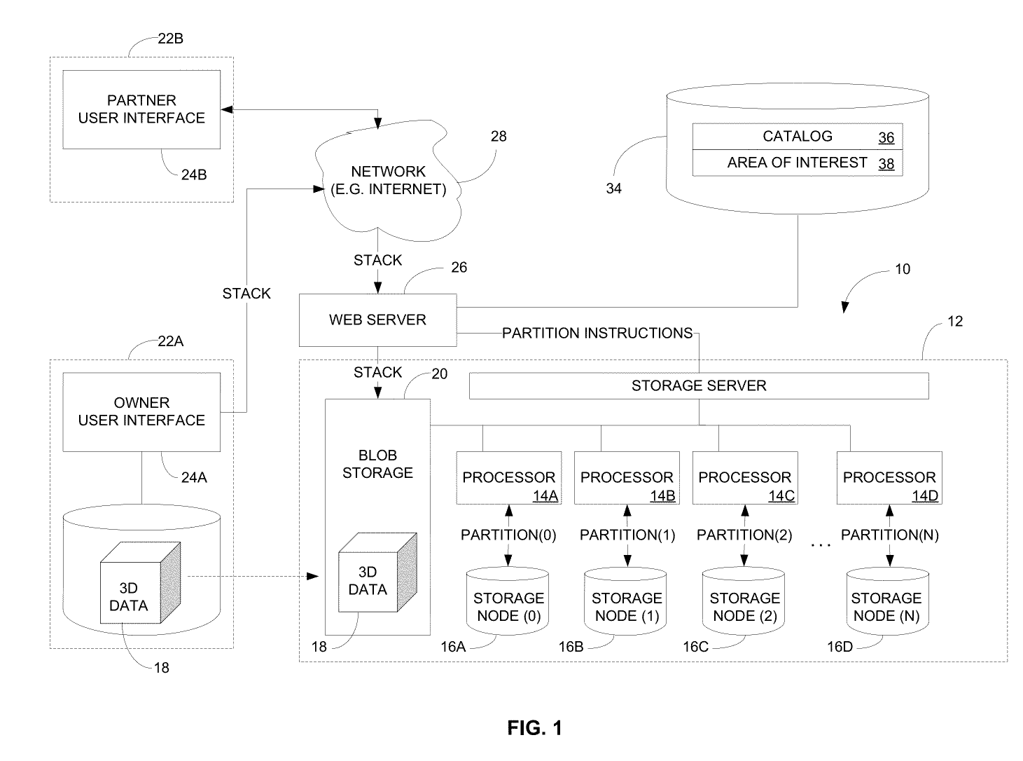

Referring now to FIG. 1, a cloud computing environment 10, and particularly a cloud computing environment with cloud-based storage 12, involves numerous distinct processors and/or processor threads 14, storage nodes 16 and input/output (I/O) for the storage nodes. A given storage node may be physical and/or virtual meaning that a storage node may comprise various memory and storage elements including L1 cache, L2 Cache, and hard disc storage among other things. A particular storage solution may also back-up or replicate data and may also archive data in tape-based archives or otherwise. A storage node may be virtualized such that a set of memory and storage forms one or more storage nodes or pools. Each processor may be capable of executing one or more distinct processing threads. Thus, the system set out herein contemplates a range of possible cloud storage solutions ranging from a dedicated processor, I/O and storage, to a processor or processors executing various threads for reading and writing data into and out of a virtualized storage node. As used herein, the term “thread” contemplates a processor that is able to execute computing operations. A processor is able to execute at least one thread, and some processors are capable of executing many threads. Such processors may be referred to or otherwise include multi-threaded processors, parallel processors, multi-core processors (where each core is able to execute one or more threads), and the like.

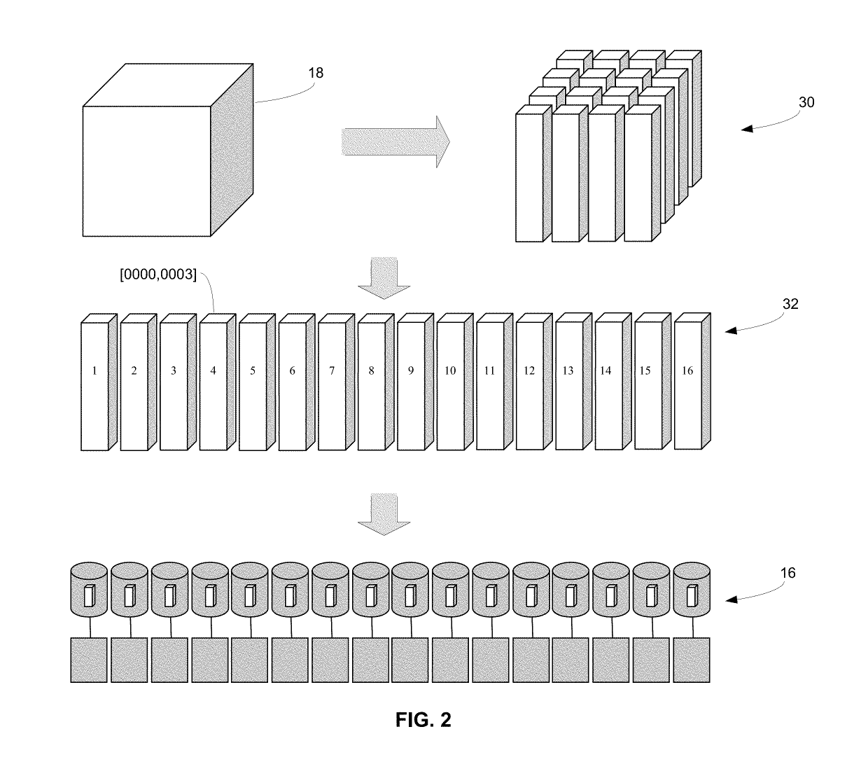

Referring to FIG. 2 and others, in one possible implementation of this disclosure, a 3-D data set 18 is partitioned or otherwise divided into discrete partitions 30. When referring to a seismic stack, the data may be divided into bricks or columns. Each discrete column is then stored in a discrete storage node 16 in the cloud. A processor thread may then act on the discrete chunk acting in parallel with other treads acting on other chunks. Thus, data may be loaded and stored in the cloud in parallel, and data may be read from the cloud in parallel. Stated differently, each seismic partition is stored in its own storage node. When accessing the data, threads may be launched on a per node basis to access the particular data within a given node to complete the I/O request.

In one particular case, the storage node involves a non-relational database 34 with underlying disc for physically storing the data. When the owner uploads data to the cloud, an entry or row in the database is populated with information concerning the uploaded data. The information and rows of information describing the data stored in the cloud for a given user and for a collection of users may be referred to herein as a catalog 36. Among other things, the catalog defines attributes of the data that may be shared with other parties, such as seismic data that may be licensed to a partner.

In addition to the catalog data, the database may also contain area of interest (AOI) data 38 populated by one or more partners and other users. The AOI data identifies the types of data that a partner may seek to license or otherwise obtain access or use rights to, and causes the system to notify the partner when such data is made available in the system such as when such data to the catalog. Besides using the AOI data is added to be notified of certain events, a partner may also directly search the catalog for data of interest.

Various aspects of the method described hereafter may be performed or managed by the web server 26. An owner may access and interact with the system 26 though a user interface 24A running at a client device 22A. The client device may be running a browser and may access and or otherwise interact with the system by way of a network 28. Similarly, a partner also includes a client device 22B which may be running a user interface 24B. Also similarly, the partner client device 24B may be running a browser to access and interact with the system through web server 26. Generally speaking, both the owner and partner are registered users of the system, and when accessing the system, such as through a uniform resource locator, will be displayed various public pages as well as customized pages based upon their subscription and user identification. While the diagram shows the client device 22A as including some form of memory or storage holding a raw data cube 18, it is contemplated that partner devices may have the same functionality as partners may also be data owner, and owners may also be partners. The client device is generally any form of computing device, such as a work station, personal computer, portable computer, or tablet, capable of interacting with the web server 26 as well as the overall system to which it is a part.

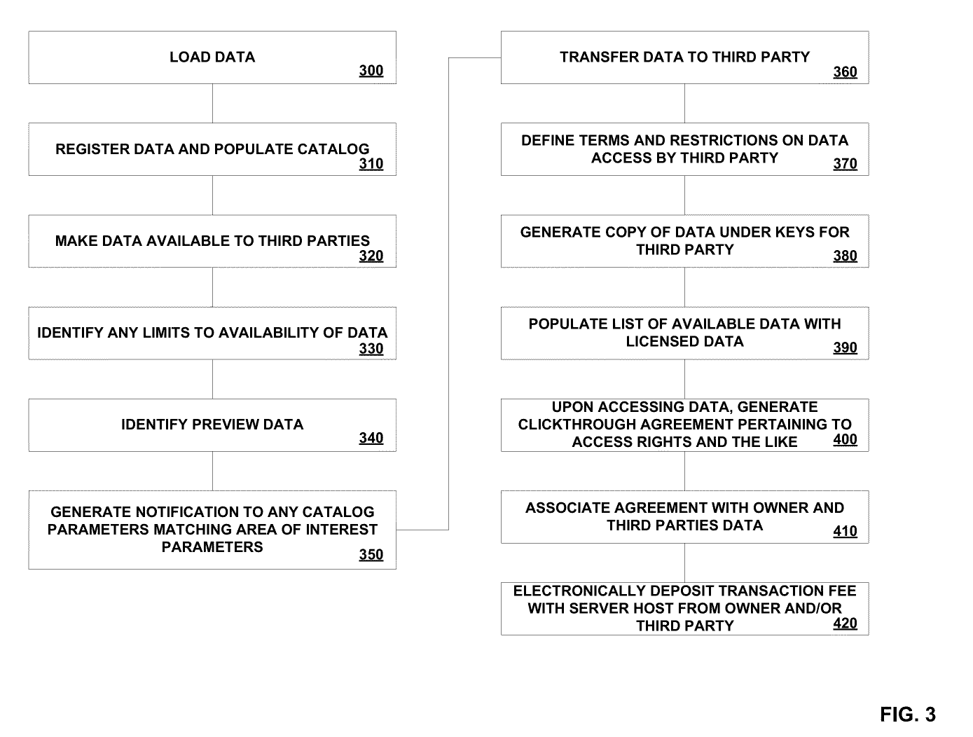

FIG. 3 is a flowchart illustrating one possible method of making seismic data or other forms of data, and particularly 3D data, available for use by third parties and granting those parties access to the data, in conformance with the present disclosure. To begin, a client, which will often be the owner of the data set, using the client device 22A contacts a transaction system through web server 26 to load the data into the cloud storage 12Y (operation 300). The transaction system, in this example, may include the web server 26 configured to partition and interact with the cloud storage 12 to store the data as well as to extract the stored data from the partitions. The transaction system also includes the database 34 including the catalog data 36 and area of interest data 38.

During the processing of loading the data into the cloud, the owner, through the user interface 24A, registers the data and may populate certain fields of the catalog (operation 310). As will be discussed, some catalog fields may also be populated by automatically extracting the relevant data from the data set, reading metadata associated with the data set, reading trace headers within the data set, and other automatic methods.

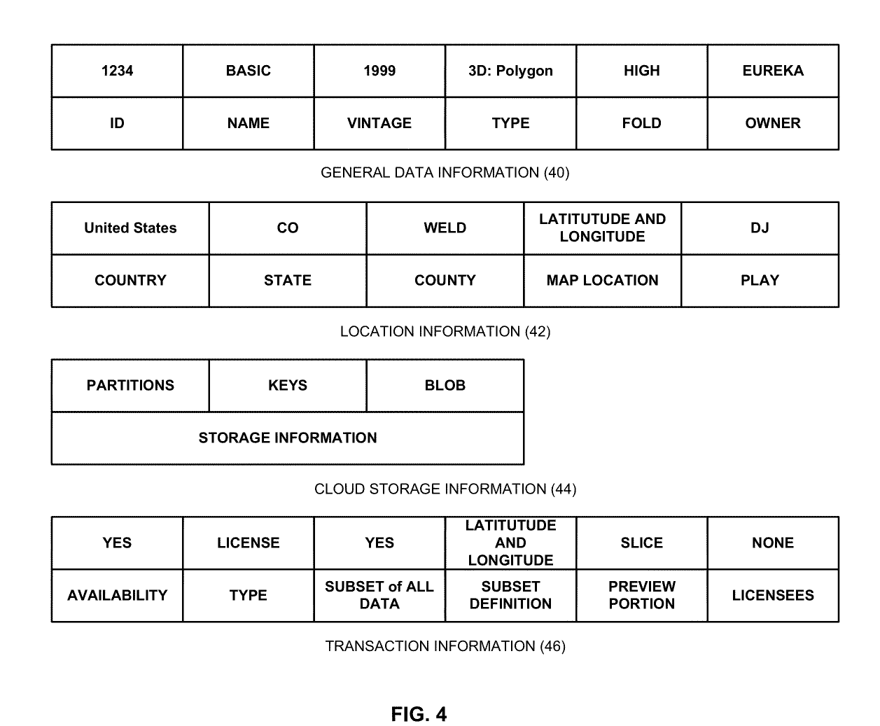

FIG. 4 is an example of one row of a catalog where each field within the row involves information that may be obtained manually or automatically during the registration process. These fields may also be changed, updated, added, edited or otherwise changed after the registration through the user interface 24A, through batch processes, or by other means.

In the specific case of seismic data and as illustrated in FIG. 4, a catalog entry for a particular data set loaded to the storage platform and potentially available for access by third parties, may include a set of general data information fields 40, a set of location information fields 46, a set of cloud storage information fields 44, and information fields 46. The general data information fields may include a data set ID, a data set name, the vintage of the data set, a type of data set, a fold of the data set, and an owner of the data set. The data set ID is a unique key, different from any other dataset ID in the system. The data set name is simply the name of the data set as defined by the owner through the user interface or as the data set was named at the time it is uploaded. In this example, the data set name is “Basic.” The vintage represents the year the seismic stack was created—in this example, 1999. Potential third parties may use the vintage as a filter for identifying data sets of interest as data obtained in different years may be of varying quality depending on the techniques and technology available at the time for conducting the seismic survey. The data type field may represent the type of data set available. In the case of seismic data, the type may be 3 dimensional seismic data, which appears as a three dimensional polygon (as in the example) or 2 dimensional seismic data, which appears as a 2 dimensional polyline. “Fold” is a term representing the overall quality of the seismic data; hence the fold field includes a value for the fold quality of the seismic data—in this example, “high.”

The catalog entry for the data set also includes location information fields 42 pertaining generally to the geographical location associated with the data set (e.g. where the seismic survey was conducted). Depending on the type of data, some or all of the catalog entries may differ. For example, medcal data would not necessarily require location information but may instead require hospital, clinic, technician, doctor and other fields. The location information may be arranged in many different ways. In this example, which pertains specifically to data from the United States, the location information includes a country field (e.g., United States of America), a state field (e.g. Colorado) and a county field (e.g. Weld). Besides the high level country, state and county data, the location information also includes specific latitude and longitude or other forms of GPS coordinates for the data. In the case of a cube, the map location information may include latitude and longitude information for each corner of the cube, thereby manifesting as a closed polygon in map view. In the case of a seismic line, the map location information may include latitude and longitude data for each point along the 2-D seismic line, thereby manifesting as a polyline in map view. Finally, the location information may also include a “play” value. The play is industry jargon for the specific formation that may or does contain oil and gas reserves. In this example, the play is “DJ,” which is a term representing the DJ Basin (also referred to as the Denver-Julesburg Basin) that is located in Northeast Colorado and parts of other neighboring states, and extends into Weld County, Colorado. The DJ Basin includes the Niobrara Shale Formation that has oil and natural gas reserves. For any catalog, additional fields may be added to further define and provide for searching of a data set. For example, a catalog entry may include other “play” entries to account for different terms which may be used to search for the same data, such as “Denver Julesburg” or “Niobrara.” Additional, any given field may be populated with additional data and conventional database searching techniques may be used to search the full information.

The catalog may also include storage information with fields for partitions, keys and the blob location for the data set, if not yet partitioned. This information is stored in the catalog but is not viewable or directly alterable by a user.

The catalog row for any given data set also includes transactional information fields 46 which define various parameters used to identify data that is available to third parties, such as through licensing, and to define the type of access available among other information. Referring again to FIG. 3, as the time of registration or afterward, the owner may make certain data available to third parties (operation 320), such as through the user interface 24A of the client device 22A. As with other actions at the user interface, a browser is used to access the web server 26, which the look pages at the client device through which the owner can define or otherwise establish the third party availability of a data set. The steps involved with making a data set available to a third party include setting the availability field as yes or no, within the transaction information 46 of the BASIC catalog entry, for example. The owner also defines the type of availability. In this example, the type is a license to use the data, which usually has limitations on the extent of the partner's use. The owner may also make the data available for outright sale, or to exchange access to the data for some other proprietary right, such as access to other data sets that may be owned by other third party subscribers to the system. The owner may also simply indicate that the type of availability is negotiable. These various type options, along with other field options, may be selectable through a drop down menu or other html mechanisms.

Besides indicating the gross level of availability, the owner may also define or otherwise identify limits on the availability of the data (operation 330). For example, the owner of a data set may have active wells on a certain portion of property associated with a seismic survey and so may not provide access to the seismic data for those areas, but may make other portions of the data available to a third party. In such a case, the user defines the subset of data available through some form of geographic identifiers including latitude and longitude information or GPS related data parameters. The user may also make a limited set of the data available for preview (operation 340), whether making all or some of the data available to third parties.

In some instances, the data set may be registered for the purpose of providing access to a contractor that will take some action on the data set on behalf of the owner. In such instances, a preview portion is likely not required although the owner may not grant the contractor access to the entire data set. In such situations, different fields might be included in the catalog, including identifying a specific contractor or contractors with permission to access the data, as well as the type of access for the contractor, which may identify the type of work that the contractor will perform on the data.

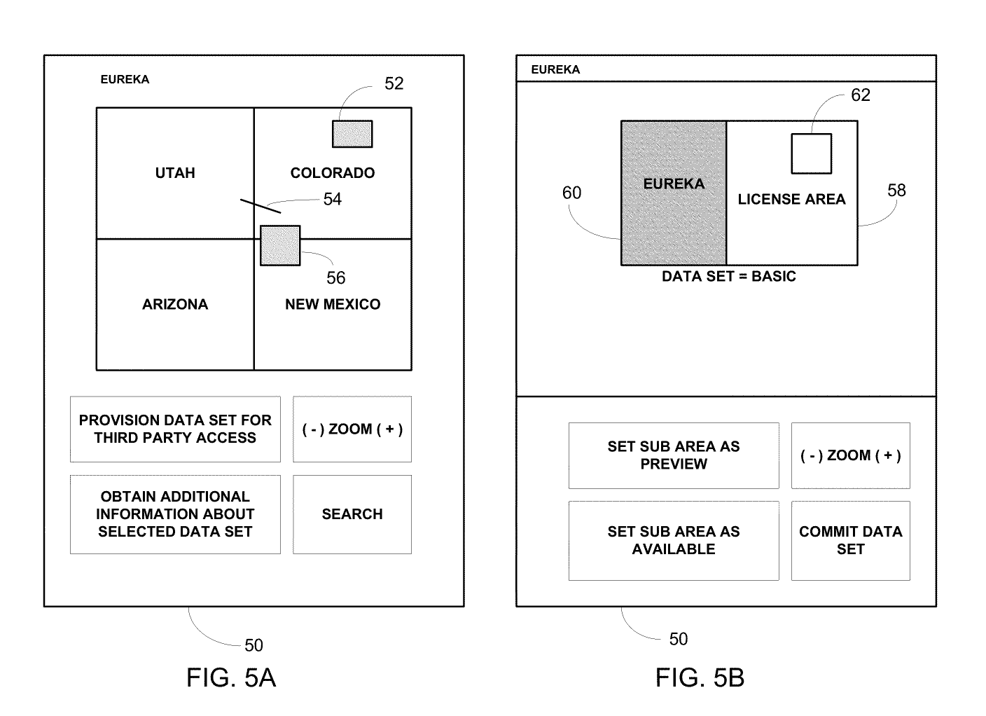

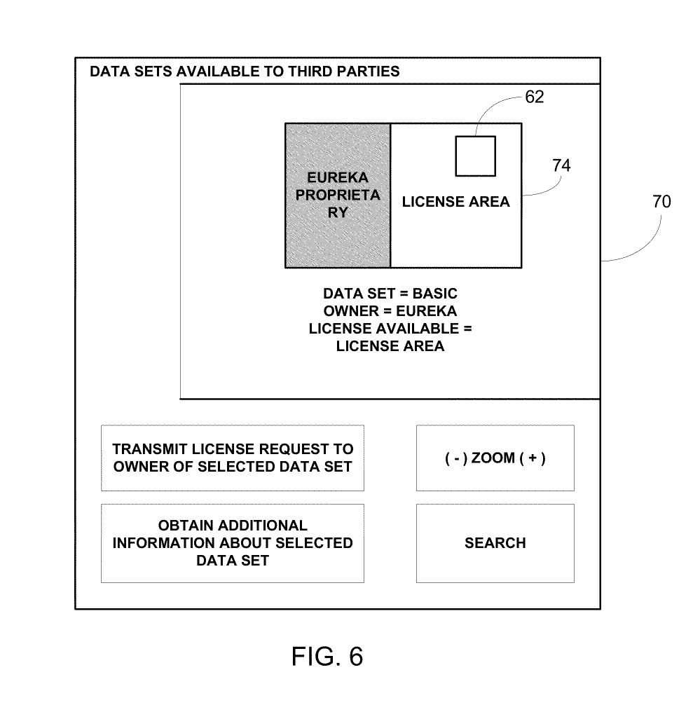

The owner may manually enter information defining the limits to third party viewing and access of data. Additionally, implementations of the present disclosure may deploy a graphical user interface for some or all of the same functions. FIGS. 5A and 5B illustrate a particular graphical user interface 50 by which an owner may review seismic data sets uploaded to the system and FIG. 6 illustrates a graphical user interface 70 by which a potential partner may review data sets available from owner's for some form of use.

First, referring to the client GUI, through the use of the latitude and longitude information in each trace header of a data set, the system can graphically identify the location and contours of data sets loaded and partitioned in the system. In the illustrated GUI, the BASIC data set 52 as well as a polyline 54 and a second data set 56 are shown for the owner Eureka. By selecting the BASIC set, the owner is presented with the GUI in FIG. 5B, where the owner, through a touch screen, mouse, key strokes, and various graphical functions, may define a license area 58, proprietary area 58, as well as a preview area 62. Since the contents of the data set can include latitude and longitude data (e.g. in the trace headers), these graphical definitions can be translated to the data used to populate the catalog.

As shown in FIG. 6, a potential partner, that is a registered user of the service, may enter a section of the service, such as by using a browser to navigate to a correct link of a web page, and access a map 72 that uses the catalog entries of data sets made available by various owners, and graphically identifies those data sets on an interactive map. The partner map, as well as the client map, may extend across any applicable geographic area and may be zoomed in or out to view the map with greater or lesser detail. As shown in FIG. 6, the potential partner has zoomed into an area 72 that illustrates the BASIC data set 74 and graphically depicts the licensable portion 58, the proprietary portion 60 and the preview area 62. If the partner selects the preview portion, the system will transfer the partner to a portion of the site that allows the user to select inlines, crosslines, time slices, or other portions of the preview data by accessing the owner's data set, and providing for the use of the data for the partner to preview in accordance with techniques discussed in application Ser. No. 13/654,316.

Alternatively, the preview data may be one or more existing images for crosslines, inlines, time slices, complex surfaces and the like. In such a situation the partner would not be required, necessarily, to use a viewing program and interact with the system to generate selected images. Rather, the partner would select a particular inline, etc., of the data and those sections would be displayed. In such a situation, the system would allow the owner to select the type of preview images and generate those preview images when another party selects the preview area. Alternatively, might pre-generate the preview images and provide them to the user when the preview section is selected.

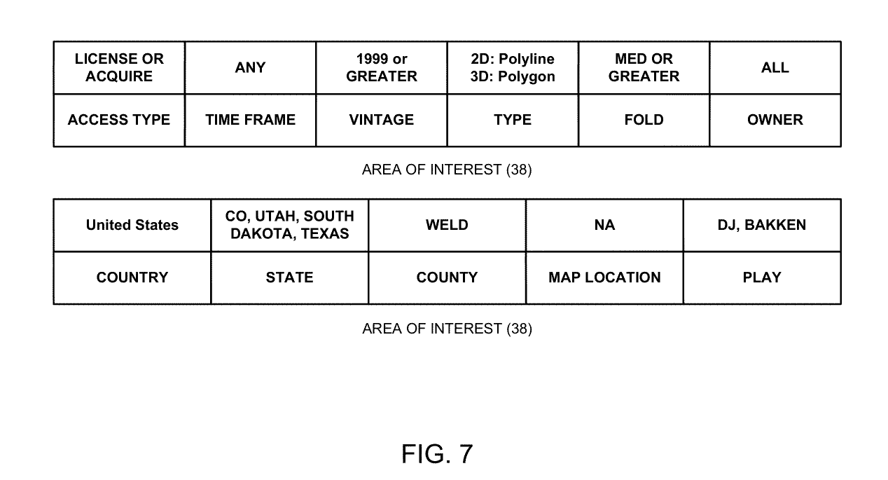

Returning to FIG. 3, besides actively searching for data sets, the potential partner may also define areas of interest 38, which are used by the system to automatic alert or otherwise notify the potential partner when an owner loads data and makes data available to third parties (operation 350). FIG. 7 illustrates area of interest fields that a potential partner may define through the partner interface 22B. As introduced above, the areas of interest may represent rows in the database 34 and may be used by the system to automatically identify data sets 18 that match some or all of the area of interest fields.

In the example of FIG. 7, the area of interest may include several different fields, only some of which are illustrated, that a partner may identify and define. As illustrated, the fields may include:

an “access type” that defines the various types of access to the data in which the partner is interested (e.g., license, trade, acquire);

a “time frame” that specifies the minimum time frame that the partner would desire access to the data (e.g., 1 year, 2 years, etc.);

a “vintage” field that specifies some limit or range of vintages for the data rights that the partner seeks (e.g., 1999 or greater);

a “type” field that indicates the types of data (e.g., 3D seismic or 2D seismic) in which the partner is interested;

a “fold” field that sets a minimum fold quality for the data;

an “owner” field that may specify particular owners of data (e.g., none or Eureka);

a “country” field identifies the country or countries for the data that the partner seeks (e.g., United States of America);

a “state” field that identifies the states (in the case of the United States or other countries having states) for the data;

a “county” field that sets the counties (in the case of the United States or other countries with counties) for the data;

a “map” location field for the partner to identify specific locations for data, which may be entered as latitude and longitude coordinates, or by selecting locations on a GUI; and

a “play” identifier that identifies any specific plays in which the partner is interested (e.g. DJ and Bakken).

So, for example, a partner might identify the DJ play as an area of interest, and when the owner uploads a data set and makes that data set available to third parties with the DJ play identified in the catalog entry, the partner is provided with a notification, which may be an automatically generated email to the registered user or users of the partner, an alert on a home page of the system that is tailored for the partner when that partner logs into the system, or some other form of automatic notification. As with catalog fields, the area of interest fields may be tailored to the types of data being loaded and accessed through the system.

Regardless of the means of notification or otherwise, when a partner negotiates some form of license or other form of access with the owner, the owner transfers the corresponding data to the partner within the system (operation 380). Similarly, if the owner decides to grant access to a contractor or other party, the owner transfers the data set to the contractor or other party within the system. Generally speaking, the system creates a copy of the dataset from the owner's storage area to the partner's storage area within the larger system. Because the system may be a multi-tenant system, all of the data is storage in a common physical area under different primary keys. But from a logical perspective, datasets of the owner and of the partner, are not intermingled—separate copies exist.

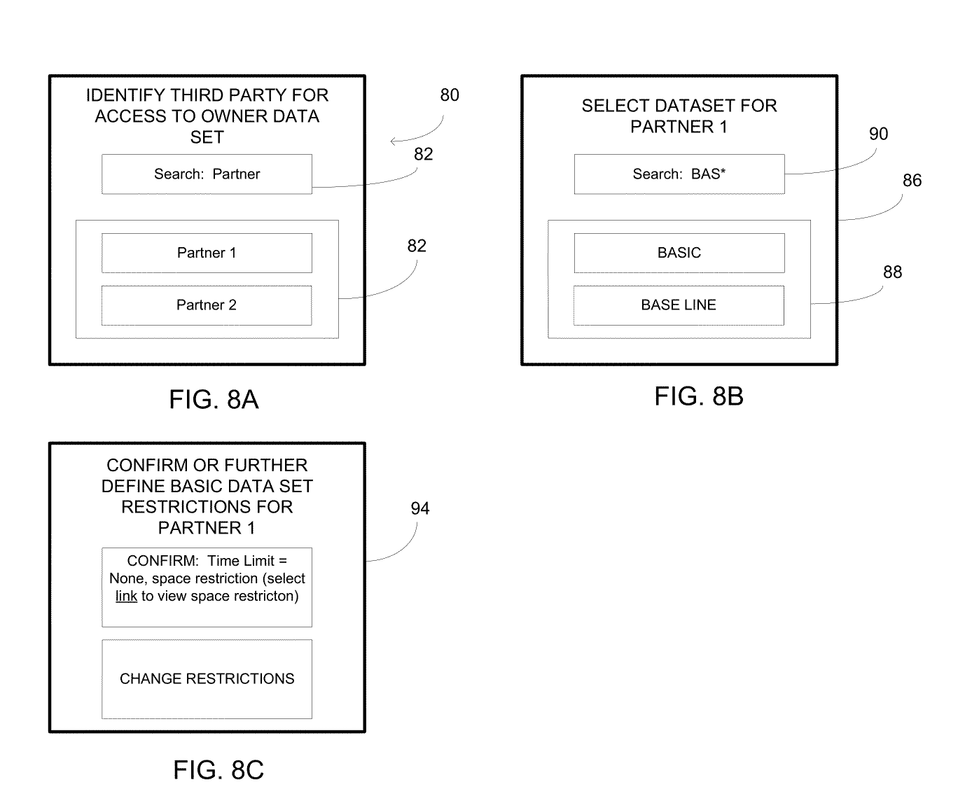

FIGS. 8A-8C illustrate a sequence of representative GUI's by which an owner may transfer the BASIC data set to partner 1 in order to illustrate the flow. Referring first to FIG. 8A, the owner is provided with a screen 80 indentifying a list of partners 82 to which the owner may transfer a data set. The list may be populated based on a search 84 or may be populated by other means. In any event, the owner selects the proper partner, in this case Partner 1. In a second GUI 86 the owner is then presented with a list of possible data sets to transfer to the owner. Similar to the partner list, the data set list may be populated based on a search or by other means. In this example, the owner selects the data set “BASIC.” Next, the system, through the catalog entries, identifies and displays any access restrictions on the data. In the case of BASIC, the owner can confirm that only a portion of the data will be made available to the partner. At this point, the owner also has the option to define or change or any access restrictions. When the access restrictions are complete, the owner selects enter which causes a copy of the appropriate data to be transferred to the partner under keys to partitions accessible to the owner (operation 380).

Thus, copies of the traces corresponding to the data set or restricted data set are stored in the partner's partitions. When the data has been transferred to the partner, a link to the data will be provided at the partner user interface 24B. Thus, the partner need merely select the link and the partner will be able to view and manipulate the data according to the methods described in 13/654,316. The data may be copied by a short batch process, which may execute on multiple threads, to the partner's storage space under keys by private to the partner such that only the partner can access the copy.

Depending on the implementation, during the first access of the data, the partner, contractor, or other party is provided with a click-through agreement (operation 400). The click-through agreement may be a standard form agreement that the owner may select from a list of options the agreement may define certain rights or restrictions on the data including restrictions on derivation and transfer, and may specify standard activities but limited activities of a contractor. It is also possible for the owner to load a more complex customized agreement reflecting negotiated terms between the owner and the partner or contractor. In such an instance, the customized agreement is presented at the click-through stage and must be electronically executed for the partner to obtain access to the owner data.

In either case, the electronically signed agreement is electronically attached or otherwise linked with the data set of the owner (operation 410). Thus, when the owner views a list of its data sets in the system, the BASIC data set will include a link that causes the signed document to be presented at the user interface. The same happens for the partner. When a plurality of access rights are granted for a data set, those agreements are arranged in date order creating a providence listing of the data set viewable by the owner.

Finally, at the close of the transaction or at some other point in the process flow, a transaction fee is electronically transferred from the owner and/or partner to the service managing and providing the storage and licensing platform (operation 420).

Besides licensing or selling data sets, aspects of the present disclosure are also useful for providing contractors, vendors, and others, access to the data set for other purposes. Contractors may provide any number of possible services on the data for the owner. The system allows the owner to transfer some or all of the data set to such parties. The transfer may be for a limited time, may be for a limited portion of the data, and may be otherwise restricted and limited. Such transfers may also be accompanied by click through agreements. In the case of a contractor the agreement may require confidentiality and may limit the contractor's use of the data, among other possible restrictions.

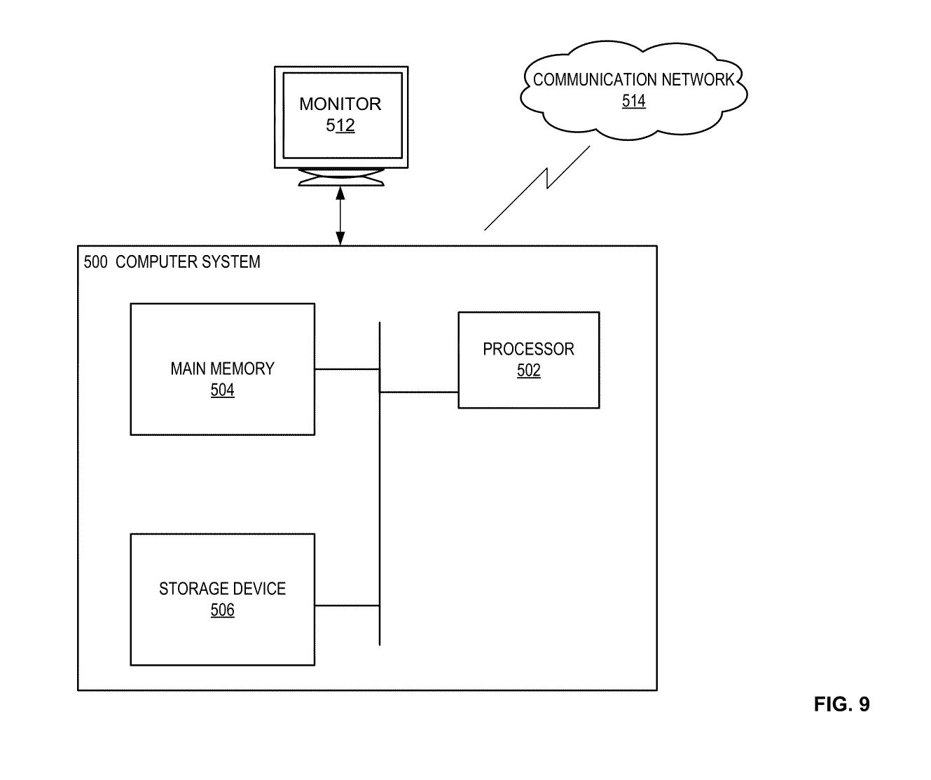

The various inventive concepts described above may be implemented on virtually any type of computer regardless of the platform being used. For example, as shown in FIG. 9, a computer system 500 may be used in the server 26, and may include a processor 502, associated memory 504, a storage device 506, and numerous other elements and functionalities typical of today's computers (not shown). The computer 500 may also include input means, such as a keyboard and a mouse and output means, such as a monitor 512. The computer system 500 may be connected to a local area network (LAN) or a Wide area network (e.g., the Internet), such as communication network 514, via a network interface connection (not shown). Those skilled in the art will appreciate that these input and output means may take other forms. For purposes of the present device, the computer may be used for the web server 26, the storage server 12, or the computing device 22 whereby a user uploads data to the storage cloud or requests data from the cloud by way of the user interface 24.

Further, those skilled in the art will appreciate that one or more elements of the computer system 500 may be located at a remote location and connected to the other elements over a network. The invention may be implemented on a distributed system having a plurality of nodes, where each portion of the invention (e.g., the operating system, file system, cache, application(s), etc.) may be located on a different node within the distributed system, and each node may correspond to a computer system. Alternatively, the node may correspond to a processor with associated physical memory. The node may alternatively correspond to a processor with shared memory and/or resources. Further, software instructions to perform embodiments of the invention may be stored on a tangible computer readable medium such as a compact disc (CD), a diskette, a tape, a digital versatile disk (DVD), or any other suitable tangible computer readable storage device.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

1. A method of providing a party access to proprietary multi-dimensional data sets comprising the operations of:
at one or more computer servers configured to provide a data set transaction service,
receiving a proprietary data set from a first party, the proprietary data set partitioned and stored across a plurality of storage nodes;
obtaining registration information for the data set, the registration information including at least one indication that the data set is available for a transaction; and
providing for notification that the data set is available for a transaction.

2. The method of claim 1 wherein the proprietary data set is a seismic data set.

3. The method of claim 2 wherein the registration information populates a catalog of data set identifying parameters for the proprietary data set.

4. The method of claim 3 wherein the registration information comprises at least one of general data set information, location information, storage information and transaction information.

5. The method of claim 4 wherein the location information includes at least one geographic identifier for the seismic data set.

6. The method of claim 5 wherein the location information comprises at least two latitude and longitude coordinates of the data set, the at least two latitude and longitude coordinates associated with locations of a geographic area associated with the data set.

7. The method of claim 6 wherein the at least two latitude and longitude coordinates are extracted from plurality of traces of the data set.

8. The method of claim 2 wherein the operation of providing for notification that the data set is available for a transaction comprises comparing the registration information to an area of interest table in the database, the area of interest defining a plurality of information fields for any second party interested in obtaining automatic notifications when data sets are made available for a transaction and that conform with one or more of the information fields defined by the second party.

9. The method of claim 8 wherein the area of information fields comprise at least one of location information, owner information, data set information and transaction information.

10. The method of claim 2 further comprising generating one or more web pages for access by the first party, the one or more web pages defining at least one graphical user interface that displays the seismic data set in a map layout, the graphical user interface configured to allow the first party to perform at least one of designate the data set as available for the transaction, designate a portion of the data set as available for the transaction, and establish a preview area of the data set, the preview area providing a second party with the ability to generate viewable images of the seismic data within the preview area.

11. The method of claim 10 further comprising generating one or more web pages for access by the second party, the web pages accessible by the second party defining at least one graphical user interface that displays the seismic data set in a map layout and allows the second party to select the data set and generate a notification to the owner of a possible transaction with the subscriber.

12. The method of claim 11 further comprising receiving a command from the first party at a client device to transfer the data set or a portion thereof to the second party, the transfer causing a copy of the data set or a copy of the portion thereof to be stored in one or more storage nodes accessible by the second party.

13. The method of claim 12 further comprising presenting the second party with an electronically executable agreement and linking the agreement with the data set upon electronic execution of the same.

14. The method of claim 11 further comprising electronically transferring a fee from at least one of the first party and the second party to a service provider hosting the data set transaction service.

15. A system of providing a party access to proprietary multi-dimensional data sets comprising
at least one computer server including a computer readable media having instructions thereon for providing a data set transaction service, the data set transaction service configured to:
receive a proprietary data set from a first party;
obtain registration information for the data set, the registration information including at least one indication that the data set is available for a transaction; and
provide for notification that the data set is available for a transaction.

16. The system of claim 15 wherein the system is further configured to partition and store the data set across a plurality of storage nodes and wherein the proprietary data set is a seismic data set.

17. The system of claim 16 wherein the registration information populates a catalog of data sets identifying parameters for the proprietary data set.

18. The system of claim 17 wherein the registration information comprises at least one of general data set information, location information, storage information and transaction information.

19. The system of claim 18 wherein the location information includes at least one geographic identifier for the seismic data set.

20. The system of claim 19 wherein the location information comprises at least two latitude and longitude coordinates of the data set, the at least two latitude and longitude coordinates associated with locations of a geographic area associated with the data set.

21. The system of claim 20 wherein the at least two latitude and longitude coordinates are extracted from plurality of traces of the data set.

22. The system of claim 16 wherein to provide for notification that the data set is available for a transaction comprises comparing the registration information to an area of interest table in the database, the area of interest defining a plurality of information fields for any second party interested in obtaining automatic notifications when data sets are made available for a transaction and that conform with one or more of the information fields defined by the second party.

23. The system of claim 22 wherein the area of information fields comprise at least one of location information, owner information, data set information and transaction information.

24. The system of claim 16 wherein the data set transaction service is further configured to generate one or more web pages for access by the first party, the one or more web pages defining at least one graphical user interface that displays the seismic data set in a map layout, the graphical user interface configured to allow the first party to perform at least one of designate the data set as available for the transaction, designate a portion of the data set as available for the transaction, and establish a preview area of the data set, the preview area providing a second party with the ability to generate viewable images of the seismic data within the preview area.

25. The system of claim 24 wherein the data set transaction service is further configured to generate one or more web pages for access by the second party, the web pages accessible by the second party defining at least one graphical user interface that displays the seismic data set in a map layout and allows the second party to select the data set and generate a notification to the owner of a possible transaction with the subscriber.

26. The system of claim 24 wherein the data set transaction service is further configured to receive a command from the first party at a client device to transfer the data set or a portion thereof to the second party, the transfer causing a copy of the data set or a copy of the portion thereof to be stored in one or more storage nodes accessible by the second party.

27. The system of claim 26 wherein the data set transaction service is further configured to present the second party with an electronically executable agreement and linking the agreement with the data set upon electronic execution of the same.

28. The system of claim 24 wherein the data set transaction service is further configured to cause an electronic transfer of a fee from at least one of the first party and the second party to a service provider hosting the data set transaction service.
